(19) United States
(12) Patent Application Publication
(10) Pub. No.: US 2010/0133410 A1
(43) Pub. Date: Jun. 3, 2010

(54) ARRANGEMENT FOR FASTENING FUNCTIONAL UNITS IN A VEHICLE

(75) Inventors: Roland Gruener, Tamm (DE); Laurent Raddaz, Tamm (DE); Rainer Lipfert, Heilbronn (DE); Bernd Binder, Asperg (DE); Martin Hasch, Schwieberdingen (DE); Michael Barwanitz, Sersheim (DE); Karl Simonis, Illingen (DE); Daryl Harrigan, Coventry (GB)

Correspondence Address: OSHA LIANG L.L.P., TWO HOUSTON CENTER, 909 FANNIN, SUITE 3500, HOUSTON, TX, 77010, US

(73) Assignee: VALEO SCHALTER UND SENSOREN GMBH, Bietigheim-Bissingen (DE)

(21) Appl. No.: 12/597,983

(22) PCT Filed: May 9, 2008
(86) PCT No.: PCT/EP2008/003728

§ 371 Date: Oct. 28, 2009

(30) Foreign Application Priority Data
May 10, 2007 (DE) 102007021860.7

(51) Int. Cl. B60R 11/00

(52) U.S. Cl. 248/475.1

(57) ABSTRACT

An arrangement for fastening functional units in a vehicle is disclosed. The arrangement includes a carrier part arranged between a functional unit and the vehicle. The carrier part is designed in one piece and includes, on the side facing the vehicle, mechanical connecting elements which in each case are specific to the vehicle. On the opposing side facing the interior of the vehicle, the carrier part includes mechanical connecting elements adapted to the functional unit. A roof module is formed by the arrangement, which is attached approximately centrally in the transition region of the vehicle body to the front windscreen.

### PRIOR ART

The invention relates to an arrangement for fastening functional units in a vehicle, for example for supporting sensor elements, operating elements and/or display elements in a so-called roof module of a vehicle, according to the preamble of the main claim.

It is known, for example, from DE 100 44 738 C2, that in a motor vehicle in the visible or operating range of the driver or a further passenger, a carrier part is preferably arranged in the roof lining of the motor vehicle, which has mechanical and electrical receiving and/or coupling parts, by which individual functional units, such as switches or displays, may be connected there mechanically and electrically. To this end, the known arrangement has three regions respectively offset by 120° , with the receiving and/or coupling parts as receiving recesses into which the functional units may be placed.

It is further known from this prior art that the carrier part is made up of a fastening part which may be connected to the frame of the respective motor vehicle and a supporting part comprising the receiving recesses described above. The supporting part is thus still pivotably connected to the fastening part, transversely to the axis of extension of the carrier part, but the carrier part as a whole being fixedly connected to the roof lining, possibly even enclosed in foam and also being able to be produced together with the roof lining during the assembly of the motor vehicle.

It is further known from DE 20 2004 020 891 U1 that a roof module may also be attached as a functional unit carrier to the roof lining of a motor vehicle such that it reaches into regions of the motor vehicle in which external events may be detected using appropriate sensors. For example, in this case rain sensors or cameras may be attached in the region of the windscreen of the vehicle.

### DESCRIPTION OF THE INVENTION

The invention is based on an arrangement for fastening functional units in a vehicle comprising a carrier part, which is arranged between the at least one functional unit and the vehicle. Advantageously, according to the invention it is provided that the carrier part is designed in one piece in a particularly simple manner and thus on the side facing the vehicle comprises mechanical connecting elements which in each case are specific to the vehicle and on the opposing side facing the interior comprises mechanical connecting elements which in each case are adapted to the at least one functional unit.

Preferably, by means of the arrangement a roof module is formed which is attached approximately centrally in the transition region of the vehicle body to a window, preferably the front windscreen, and the roof module is connected as a mechanical roof interface or vehicle interface via the one-piece carrier part to the cowl or crossmember as a bodywork part.

Hitherto, it was usual for such arrangements of a roof module in a vehicle to be clipped, for example, onto the roof lining of a vehicle by a specifically adapted device respectively for each vehicle or, as in the prior art mentioned in the introduction, to be provided with complex specific combinations consisting of supporting parts on the vehicle and fastening parts towards the roof module. In this case, therefore, for different vehicles, different roof modules or relatively complex combinations of parts have to be produced for the fastening in each case.

As a result of the increasing integration of further functions in such arrangements, however, increasingly complex roof modules or comparable arrangements are produced in which it is very costly to adapt said roof modules or comparable arrangements to an increasing number of different types of vehicles. With the arrangements according to the invention of a one-piece carrier part which is relatively simple to produce, substantially integral roof modules may be produced, for example, and thus said roof modules may be used in a simple manner in different vehicle types without increasing the number of different types of modules.

In a simple manner, the carrier part according to the invention forms a mechanical interface, for example with the cowl and/or crossmember at the connection of the windscreen to the body and/or to the roof structure of the vehicle. Via this carrier part, therefore, in a simple manner the roof module may be screwed, latched or fastened in a similar manner, for example to the cowl, the actual roof module also being able to remain identical in different types of vehicle. By means of the adapter function of the carrier part designed according to the invention, in this case it is possible to compensate for different spacings, contours and fastening options between the cowl and the underside of the roof module in a simple manner.

Even when the roof modules described above become increasingly large and mechanically more complicated by the increasing number of functions and subassemblies, by means of the simple capacity for easily adapting the carrier part according to the invention, the possibility may be provided of fastening the roof module in a particularly stable manner. By means of this fixed and stable fastening to be carried out in a simple manner, larger, more complex roof modules may also be fastened in a manner which is substantially without clearance and with low vibration and thus supported permanently, using the carrier part according to the invention.

With an improvement to the shape which is relatively simple to carry out or to the material of the carrier part, a reinforcement of the roof module may be achieved, the roof module itself being able to be more simply designed in terms of strength, as a result of which, costs may be saved with a roof module of relatively complex construction.

In a particularly advantageous embodiment of the arrangement according to the invention, the one-piece carrier part is provided with an extension projecting from the connecting region to the at least one functional unit, to which further functional units may be attached. For example, the extension may advantageously project into the region of a window, preferably the front windscreen, and for example carry an interior rearview mirror.

Conventionally, such interior rearview mirrors were hitherto either directly fixed, for example bonded, to the windscreen or even directly fastened to the roof lining or to the roof module, possibly via an intermediate piece. This is often very complicated in terms of assembly and also does not provide the required long-term stability. By means of the invention, however, the proposed carrier part may form with the extension a direct mechanically stable interface, for example to the cowl or the crossmember of the vehicle without a connection to the windscreen.

Also in this case, for example, a screw connection or latched connection between the interior rearview mirror and the carrier part as well as towards the cowl, may ensure the required stability as the carrier part according to the invention may already be provided with sufficient stability in a simple manner and without great structural complexity. Additionally, for eliminating the complex assembly step of bonding to the windscreen, it is also possible to replace the interior rearview mirror easily in the case of servicing in a repair workshop, for example without replacing the windscreen.

According to a further advantageous embodiment, the extension of the carrier part described above may also carry a sensor, preferably an optical sensor, for example a rain sensor, facing the window from the inside. Such a rain sensor on the extension of the one-piece carrier part may, therefore, be moved in a simple manner, for example by means of a spring-loaded positioning device, from a preassembled position into an end position with a mechanical contact to the window. Also, such rain sensors have hitherto been predominantly fixed directly to the windscreen, for example bonded, so that the advantages set forth with regard to the interior rearview mirror, of simple operation and greater stability as well as easy replaceability of the interior rearview mirror in the case of servicing, also apply in this case.

### BRIEF DESCRIPTION OF THE DRAWINGS

Embodiments of the invention are explained with reference to the figures of the drawings, in which:

FIG. 1 shows an arrangement comprising functional units in a so-called roof module of a vehicle and a carrier part according to the invention,

FIG. 2 shows a detailed view of the carrier part specific to the vehicle on one side according to FIG. 1 with a screw connection to a cowl of the body of the vehicle,

FIG. 3 shows a further view of the roof module assembled via the carrier part to the cowl, with an interior rearview mirror attached to an extension of the carrier part, and

FIG. 4 shows a detailed view of a rain sensor, which is attached to the extension of the carrier part.

### METHODS FOR CARRYING OUT THE INVENTION

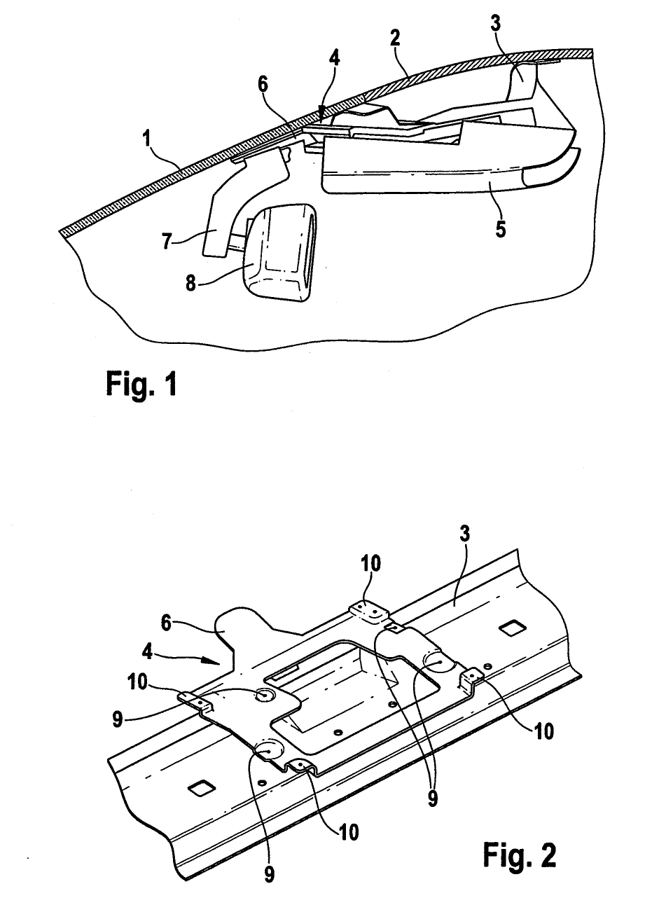

FIG. 1 shows a schematic detail of the interior of a vehicle in the region of the front window or windscreen 1, which is supported on the body 2 of the vehicle. A component of the body 2 of the vehicle is a cowl or crossmember 3 which in this case is shown in section. A one-piece carrier part 4 as a mechanical roof or vehicle interface with specific connecting elements for the respective vehicle is attached to the cowl 3 which is specific to the vehicle, on an upper side.

The carrier part 4 according to FIG. 1 has on the underside connecting elements for a roof module 5 as functional units, which in this case may thus be supported via standard connecting elements for the roof module 5. On the roof module 5, not explained in more detail here, operating or display elements known per se are present, which may be operated or observed by the passengers of the vehicle. Moreover, an extension 6 of the carrier part 4 is also visible, to which an interior rearview mirror 8 is fastened via a preferably adjustable support 7. The support 7 may, for example, be fastened via a screw connection or a latched connection to the extension 6 of the carrier part 4.

It is visible in detail from FIG. 2 that the carrier part 4 is supported on the cowl 3 at fastening points 9 of the connecting elements, specific to the vehicle, for example via screw connections. Specific connecting elements 10 are present for the roof module 5 and the extension 6, to which the roof module 5 and the interior rearview mirror 8 may be fastened (see also FIG. 1).

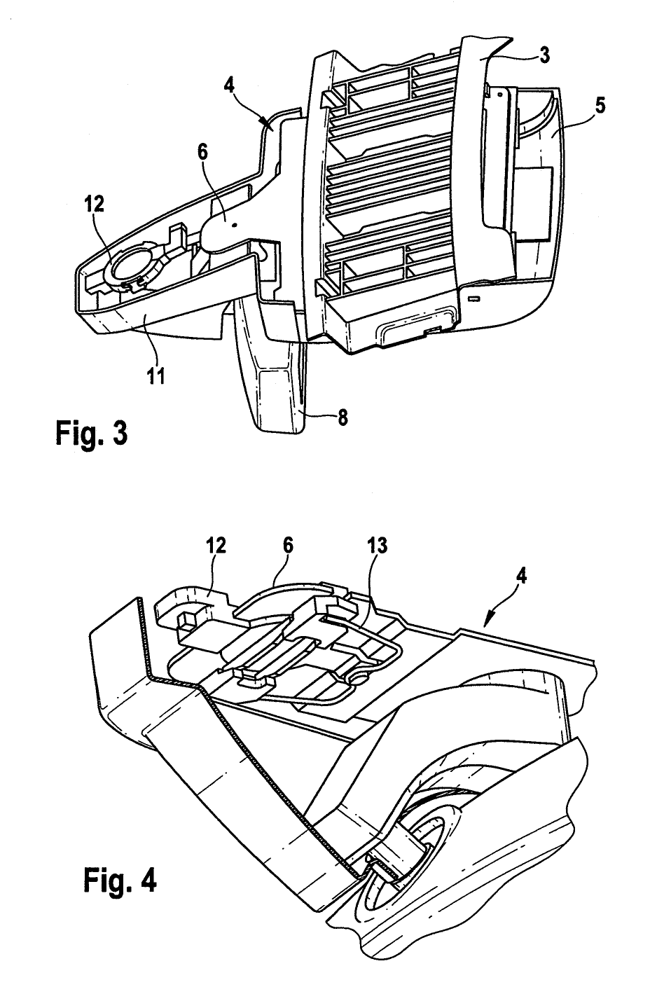

In FIG. 3 the arrangement described above is also shown from a different perspective, from which the cowl 3 is visible from above through the body, and thus carries the carrier part 4 underneath. The roof module 5 is thus visible thereunder, and it is also visible how the interior rearview mirror 8 is supported on the extension 6 of the carrier part 4.

On a widened housing portion 11 of the roof module 5, it is also indicated, in this case in FIG. 3, how further sensors, for example a rain sensor 12 facing the windscreen 1 (see FIG. 1), may be supported on the arrangement.

From these figures described above, it may thus be revealed how the roof modules 5 which are becoming increasingly complex by the integration of further functions or comparable arrangements may be adapted to increasing numbers of different types of vehicle and/or structural details of the cowl 3, respectively via the simple one-piece carrier part 4.

Referring to the view according to FIG. 3, it is also shown in FIG. 4 how the extension 6 of the carrier part 4 may be designed so that the rain sensor 12 may be attached in the region of the windscreen. The rain sensor 12 according to FIG. 4 may be moved on the extension 6 of the one-piece carrier part 4 by means of a spring-loaded positioning device 13 from a preassembled position into an end position with a mechanical contact to the windscreen 1 according to FIG. 1.

1. An arrangement for fastening functional units in a vehicle comprising:
a carrier part, which is arranged between at least one functional unit and the vehicle,
wherein the carrier part is designed in one piece, and
on a side facing the vehicle comprises a first set of mechanical connecting elements specific to the vehicle, and
on an opposing side facing an interior of the vehicle comprises a second set of mechanical connecting elements adapted to the at least one functional unit.

2. The arrangement according to claim 1, wherein a roof module is formed by the arrangement, which is attached approximately centrally in a transition region of a body of the vehicle to a window.

3. The arrangement according to claim 2, wherein the roof module is connected as a mechanical roof interface via the one-piece carrier part to a cowl or cross-member as a body part.

4. The arrangement according to claim 2, wherein the one-piece carrier part is provided with an extension projecting from a connecting region to the at least one functional unit, wherein the extension is configured to receive further functional units.

5. The arrangement according to claim 4, wherein the extension projects into the region of the window.

6. The arrangement according to claim 4, wherein the extension carries an interior rearview mirror.

7. The arrangement according to claim 5, wherein the extension carries a sensor.

8. The arrangement according to claim 7, wherein the sensor is a rain sensor.

9. The arrangement according to claim 7, the sensor on the extension of the one-piece carrier part is moved from a preassembled position into an end position with a mechanical contact to the window using a spring-loaded positioning device.

10. The arrangement according to claim 1, wherein the first and second set of mechanical connecting elements of the carrier part are screw connections.

11. The arrangement according to claim 1, wherein the first and second set of mechanical connecting elements of the carrier part are latched connections.
